(19) United States
(12) Patent Application Publication
(10) Pub. No.: US 2017/0208858 A1
(43) Pub. Date: Jul. 27, 2017

(54) ELECTRONIC CIGARETTE

(71) Applicant: Shenzhen L-Rider Technology Co., Ltd, Shenzhen (CN)

(72) Inventor: Yongsheng Li, Shenzhen (CN)

(21) Appl. No.: 15/051,687

(22) Filed: Feb. 24, 2016

(30) Foreign Application Priority Data
Jan. 27, 2016 (CN) 201620080951.9

(51) Int. Cl. A24F 1/24; H05B 3/22; A24F 47/00

(52) U.S. Cl. CPC A24F 1/24; A24F 47/008; H05B 3/22

(57) ABSTRACT

Disclosed is an electronic cigarette, which includes a case body, a bottom cover mounted on the case body and a burning room for accommodating tobacco. A heating net is provided in the burning room; the case body is provided with a first accommodating chamber and a second accommodating chamber in which a power supply and a control circuit are provided, the burning room being provided in the first accommodating chamber; the heating net, the power supply and the control circuit are connected in series by means of lead wires; and the electronic cigarette further comprises a mouthpiece connected with the burning room and a switch assembly for controlling the control circuit. The present invention has an advantage that the temperature of the heating net can be increased quickly so that the tobacco in the burning room can burn in a short time.

### CROSS-REFERENCE TO RELATED APPLICATIONS

This present invention claims the benefit of Chinese Patent Application No. CN201620080951.9, filed on Jan. 27, 2016; the contents of which are hereby incorporated by reference.

### FIELD OF THE INVENTION

The present invention relates to electronic atomization devices, and more particularly to an electronic cigarette with rapid heating function.

### BACKGROUND OF THE INVENTION

At present, there are a variety of flue-cured type electronic cigarettes on the market, some of which include a ceramic heater to heat the tobacco and some of which make this by using a heating wire. However, all of the existing flue-cured type electronic cigarettes have a same disadvantage of low heating speed, and it generally needs 20 seconds to reach a desired temperature.

### SUMMARY OF THE INVENTION

An object of the present invention is to provide an electronic cigarette with rapid heating function so as to overcome the defects of the existing technology.

To achieve above object, there is provided a technical solution as follow:

An electronic cigarette includes a case body, a bottom cover mounted on the case body and a burning room for accommodating tobacco, and further includes a heating net provided in the burning room; the case body is provided with a first accommodating chamber and a second accommodating chamber in which a power supply and a control circuit are provided, the burning room being provided in the first accommodating chamber; the heating net, the power supply and the control circuit are connected in series by means of lead wires; and the electronic cigarette further includes a mouthpiece connected with the burning room and a switch assembly for controlling the control circuit.

In a preferred embodiment, the heating net is an U-shaped structure, each end of which extends to form a conducting strip; and the electronic cigarette further includes two pressing strips, each of which is provided for tightly pressing the conducting strip against an edge of the burning room.

In a preferred embodiment, the case body is further provided with an opening which is connected with the burning room and is covered with a transparent cover.

In a preferred embodiment, there is a sealing ring provided between the opening and the transparent cover.

In a preferred embodiment, the electronic cigarette further includes a cover plate which is provided with a through-hole; and the transparent cover is fixed inside the through-hole of the cover plate.

In a preferred embodiment, the case body is further provided with a mounting hole formed on a sidewall thereof and connected with the second accommodating chamber; and the switch assembly includes a button which is sleeved with a support ring, the support ring being mounted in the mounting hole by an interference fit.

In a preferred embodiment, the electronic cigarette further includes a U-shaped element for fixing the support ring which has a groove formed thereon; the U-shaped element is mounted on the support ring by inserting into the groove; and the second accommodating chamber is provided with a first slot for fixing the U-shaped element.

In a preferred embodiment, the electronic cigarette further includes a support element for fixing the control circuit and the second accommodating chamber is further provided with a second slot for fixing the support element.

The present invention has good technical effect as follows: the temperature of the heating net can be increased quickly so that the tobacco in the burning room can burn in a short time.

The present invention will become more clear by means of the following description combining the accompanying drawings, which are used to illustrate embodiments of the present invention.

### BRIEF DESCRIPTION OF THE DRAWINGS

FIG. 1 is a perspective view illustrating an electronic cigarette according to an embodiment of the present invention;

FIG. 2 is an exploded view of the electronic cigarette according to an embodiment of the present invention;

FIG. 3 is a perspective view illustrating a case body of the electronic cigarette according to an embodiment of the present invention; and

FIG. 4 is an exploded view illustrating a switch assembly of the electronic cigarette according to an embodiment of the present invention.

### DETAILED DESCRIPTION OF ILLUSTRATED EMBODIMENTS

For understanding the technical content of the present invention more sufficiently, some embodiments of the present invention will now be described as follows, by way of example only, with reference to the accompanying drawings.

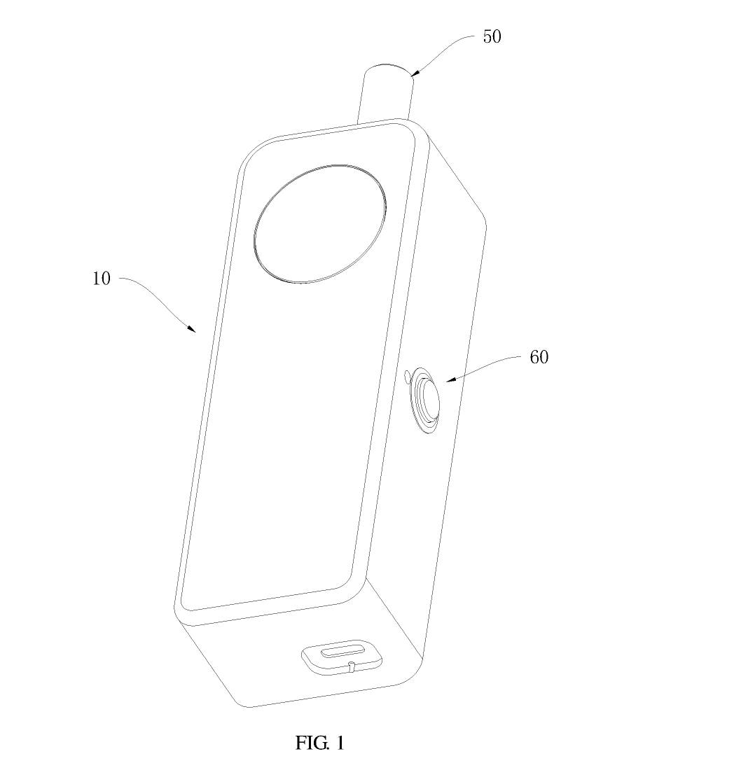

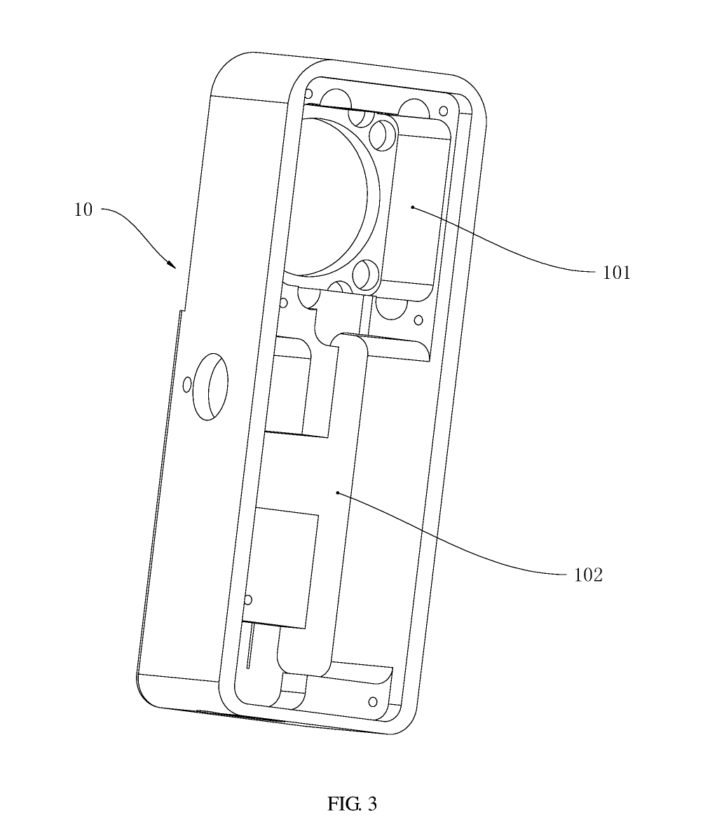

As shown in FIG. 1 to FIG. 4, an electronic cigarette includes a case body 10, a bottom cover 20 mounted on the case body 10 and a burning room 30 for accommodating tobacco. There is a heating net 40 provided in the burning room 30; the case body 10 is provided with a first accommodating chamber 101 and a second accommodating chamber 102 in which a power supply 103 and a control circuit 104 are provided, the burning room 30 being provided in the first accommodating chamber 101; the heating net 40, the power supply 103 and the control circuit 104 are connected in series by means of lead wires 105; and the electronic cigarette further includes a mouthpiece 50 connected with the burning room 30 and a switch assembly 60 for controlling the control circuit 104.

The tobacco in the burning room 30 can contact with the heating net fully so that the tobacco can be heated to burn in a short time due to fast heating of the heating net 40.

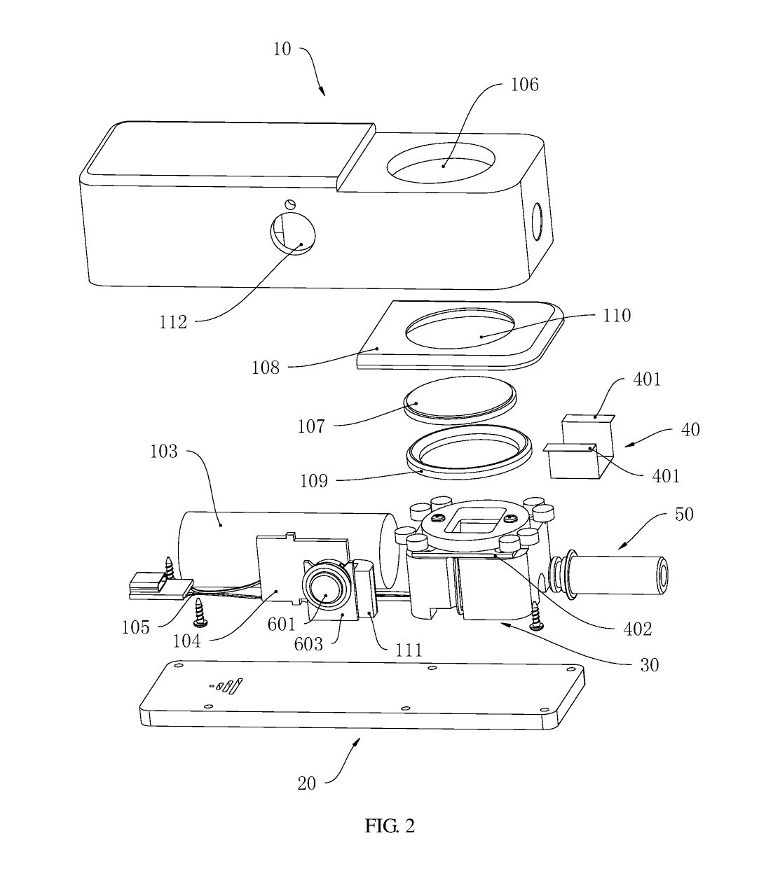

As shown in FIG. 2, in this embodiment, the heating net 40 is a U-shaped structure, each end of which extends to form a conducting strip 401. The electronic cigarette further includes two pressing strips 402, each of which is provided for tightly pressing the conducting strip 401 against an edge of the burning room 30.

As shown in FIG. 2, the case body 10 is further provided with an opening 106 which is connected with the burning room 30 and is covered with a transparent cover 107. In this embodiment, there is a sealing ring 109 provided between the opening 106 and the transparent cover 107. In this preferred embodiment, the electronic cigarette further includes a cover plate 108 which is provided with a through-hole 110; and the transparent cover 107 is fixed inside the through-hole 110 of the cover plate 108. The opening 106 is covered by the cover plate 108 which can be open or close so that it is easy to add tobacco into the burning room 30 or get the tobacco out of the burning room 30.

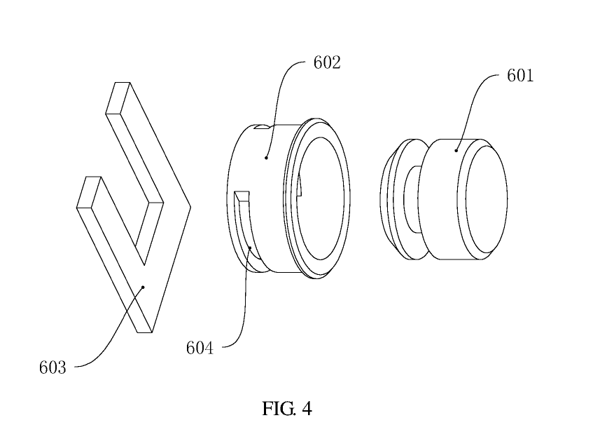

As shown in FIG. 2 and FIG. 4, the case body 10 is further provided with a mounting hole 112 formed on a sidewall thereof and connected with the second accommodating chamber 102; and the switch assembly 60 includes a button 601 which is sleeved with a support ring 602, the support ring 602 being mounted in the mounting hole 112 by an interference fit. In this preferred embodiment, the electronic cigarette further includes an U-shaped element 603 for fixing the support ring 602 which has an groove 604 formed thereon; the U-shaped element 603 is mounted on the support ring 602 by inserting into the groove 604; and the second accommodating chamber 102 is provided with a first slot for fixing the U-shaped element 603.

As shown in FIG. 2, in this embodiment, the electronic cigarette further includes a support element 113 for fixing the control circuit 104 and the second accommodating chamber 102 is further provided with a second slot for fixing the support element 111.

Above descriptions of embodiments are provided for further illustrating the technical content of the present invention, so as to facilitate understanding and it should be understood that the invention is not to be limited to the disclosed embodiments. Any technique extension and recreation according to the present invention should be included within the scope of protection of the invention.

What is claimed is:

1. An electronic cigarette, comprising a case body, a bottom cover mounted on the case body, a burning room for accommodating tobacco, and a heating net provided in the burning room; wherein the case body is provided with a first accommodating chamber and a second accommodating chamber in which a power supply and a control circuit are provided, the burning room being provided in the first accommodating chamber; the heating net, the power supply and the control circuit are connected in series by means of lead wires; and the electronic cigarette further comprises a mouthpiece connected with the burning room and a switch assembly for controlling the control circuit.

2. The electronic cigarette according to claim 1, wherein the heating net is a U-shaped structure, each end of which extends to form a conducting strip; and the electronic cigarette further comprises two pressing strips, each of which is provided for tightly pressing the conducting strip against an edge of the burning room.

3. The electronic cigarette according to claim 1, wherein the case body is further provided with an opening which is connected with the burning room and is covered with a transparent cover.

4. The electronic cigarette according to claim 3, further comprising a sealing ring provided between the opening and the transparent cover.

5. The electronic cigarette according to claim 3, further comprising a cover plate which is provided with a through-hole; and the transparent cover is fixed inside the through-hole of the cover plate.

6. The electronic cigarette according to claim 5, wherein the case body is further provided with a mounting hole formed on a sidewall thereof and connected with the second accommodating chamber; and the switch assembly comprises a button which is sleeved with a support ring, the support ring being mounted in the mounting hole by an interference fit.

7. The electronic cigarette according to claim 6, further comprising a U-shaped element for fixing the support ring which has a groove formed thereon; the U-shaped element is mounted on the support ring by inserting into the groove; and the second accommodating chamber is provided with a first slot for fixing the U-shaped element.

8. The electronic cigarette according to claim 1, further comprising a support element for fixing the control circuit and the second accommodating chamber is further provided with a second slot for fixing the support element.
